(19) United States
(12) Patent Application Publication
(10) Pub. No.: US 2024/0356816 A1
(43) Pub. Date: Oct. 24, 2024

(54) PREDICTION OF QOS OF COMMUNICATION SERVICE

(71) Applicant: Robert Bosch GmbH, Stuttgart (DE)

(72) Inventors: Maximilian Stark, Hamburg (DE); Hugues Narcisse Tchouankem, Hemmingen (DE)

(21) Appl. No.: 18/686,174

(22) PCT Filed: Aug. 31, 2021
(86) PCT No.: PCT/EP2021/073929

§ 371 Date: Feb. 23, 2024

(51) Int. Cl. H04L 41/16; H04L 41/147; H04L 41/5009; H04W 36/30

(52) U.S. Cl. CPC H04L 41/16; H04L 41/147; H04L 41/5009; H04W 36/305

(57) ABSTRACT

According to a general aspect. the present disclosure relates to a method for predicting a quality of service (QOS) of a communication service. The method includes receiving data for predicting the quality of service of the communication service and processing the data for predicting the quality of service of the communication service by a hybrid machine learning model to generate a prediction of the quality of service (QOS) of the communication service. The hybrid machine-learning model includes a first module configured to determine and/or predict one or more characteristics of the communication service. The first module encodes expert knowledge concerning the communication service in an algorithm configured to determine and/or predict the one or more characteristics of the communication module. The hybrid machine-learning model further includes a trained second module coupled to the first module. the trained second module receiving data from the first module and/or providing data to the first module for predicting of the quality of service (QOS) of the communication service.

### BACKGROUND

Today's communication services frequently involving wireless transmission employ communication protocols of ever more complex nature. This can make the prediction of a quality of service (in short “QoS”) a challenging task (in the present disclosure the term quality of service/QoS refers to any performance parameter (e.g., metric) describing the performance of the communication service, further explanation and examples are given below). In particular, quality of service can be influenced by a large number of time-varying mechanism on different layers (according to the OSI layer model) of a communication protocol used by the communication service (e.g., the physical layer and one or more higher layers). In view of this complexity, machine learning systems have been proposed to predict quality of service. However, these systems might not perform sufficiently well in some situations as the large number of factors influencing quality of service, some of them involving relatively rare events (possibly not adequately reflected in training data) make learning the underlying mechanisms difficult. For instance, a handover of a user equipment from a first cell to a second cell of a wireless communication service can drastically influence the quality of service of the communication service and can be difficult to predict in view of the fact that in modern communication protocols the handover process is a fairly complex sequence of events (see, e.g., a 5G handover procedure as defined according to 3GPP as illustrated in FIG. 4a). It can be hard to learn this pattern for a machine learning system. Therefore, several attempts to predict the quality of service of a communication service by employing machine-learning systems have not yielded entirely satisfactory results.

Accordingly, there is a need for improved techniques to predict the quality of service of a communication service.

### SUMMARY

According to a first general aspect, the present disclosure relates to a method for predicting a quality of service of a communication service. The method includes receiving data for predicting the quality of service of the communication service and processing the data for predicting the quality of service of the communication service by a hybrid machine learning model to generate a prediction of the quality of service of the communication service. The hybrid machine-learning model includes a first module configured to determine and/or predict one or more characteristics of the communication service. The first module encodes expert knowledge concerning the communication service in an algorithm configured to determine and/or predict the one or more characteristics of the communication module. The hybrid machine-learning model further includes a trained second module, preferably including one or more artificial neural networks, coupled to the first module, the trained second module receiving data from the firstmodule and/or providing data to the first module for predicting of the quality of service of the communication service.

According to a second general aspect, the present disclosure relates to a system for predicting a quality of service of a communication service. The system includes a hybrid machine-learning model including a first module configured to determine and/or predict one or more characteristics of the communication service, the first module encoding expert knowledge concerning the communication service in an algorithm configured to determine and/or predict the one or more characteristics of the communication module. The hybrid machine-learning model further includes a trained second module coupled to first module and configured to receive data from the first module and/or configured to provide data to the first module for predicting of the quality of service of the communication service.

The techniques of the first and second general aspects can have one or more of the following advantages in some situations.

First, the techniques of the present disclosure can predict a quality of service more accurately and/or reliably than some prior art solutions. In general, the first module encoding the expert knowledge can alleviate some of the short-comings of a purely trained system, e.g., in learning relatively rare events that might have a large impact on the quality of service. These events can be user equipment-centric, e.g., a user entering a garage or an elevator. In other examples, a cell of the communication service can be unusually loaded due to a rare event such as a demonstration or a concert taking place in the area of the cell. In these situations, the first module can determine or predict a characteristic of the communication service (e.g., a connection failure or a necessity of a handover) which can be used to facilitate that hybrid machine-learning model predicts a quality of service more accurately. This can be particularly relevant for wireless communication services where the above issues can be more severe than in wired communication services in some examples.

Second, the hybrid machine-learning model of the present disclosure can improve the comprehensibility of the inner workings of the model. Some purely trained models of the prior art can be “black boxes” in the sense that it can be hard to understand why the model comes to a particular prediction result. This can be an issue in various circumstances (particular when considering rare events) as the model might not use features for the prediction which generalize well (i.e., perform acceptably in rare situations) but this issue remains undetected during training as one cannot look “under the hood” of the model and the model performs acceptable in training (i.e., a generalization error). The hybrid models of the present disclosure can alleviate these issues to a certain degree as the trained second module cooperates with the first module encoding expert knowledge in a human understandable manner. This can also mean that the data exchanged between the trained second module and the first module can be interpreted by an engineer. Providing a higher comprehensibility can in turn be helpful to detect issues in the model and/or avoid failures in the field when confronted, e.g., with rare events.

Third, the improved prediction of the quality of service when using the prediction techniques of the present invention can in turn be used to improve a communication service. For instance, the prediction can be used to mitigate an effect of a drop in quality of service or to prevent a drop in quality of service, e.g., by changing an allocation of network resources.

Several terms and expressions are used in particular meaning in the present disclosure.

As stated above, the term quality of service/QoS refers to any performance parameter (e.g., a metric) describing the performance of the communication service. As a consequence, a prediction of a quality of service refers to any information regarding a future development of the respective performance parameter (e.g., the metric). In some examples, the quality of service can measure the performance from the perspective of a user/user equipment of the communication service. However, in other examples the quality of service can measure the performance from the perspective of a network equipment. Quality of service can indicate one or more of an available bandwidth, a service response time, a delay or a latency, a loss, a signal-to-noise ratio, a crosstalk, an echo, interrupts, a frequency response, loudness levels, and other performance parameters describing the performance of the communication service. The quality of service can be measured quantitatively (e.g., a service response time can be measured in milliseconds, a signal-to-noise-ratio can be measured in dB etc.). However, in other examples, the quality of service can be determined qualitatively (e.g., by defining a plurality of classes of quality of service, e.g., “background”, “conversational”, “interactive” and “streaming” in a UMTS mobile connection). A quality of service definition can be included in a telecommunication standard (e.g., 5G). However, the techniques of the present invention can also be applied for proprietary (i.e., non-standardized) definitions of quality of service. A prediction for a quality of service can also include a binary information (e.g., “service available” or “service not available”). In some examples, the prediction of the quality of service can include an output of the first module (i.e., a characteristic of the communication service). Further examples for quality of service parameters will be discussed below.

A “communication service” can be any concrete process of providing data to and/or receiving data from one or more components (e.g., user equipment) via a communication network. A communication service generally is executed according to a defined technical protocol, which can but does not have to follow a particular standardized communication protocol (e.g., 5G). A communication service can include establishing a connection between two network nodes (e.g., one of them being a user equipment) to communicate data in a unidirectional or a bidirectional manner. The communication service can provide audio or video telephony services but also data services (e.g., receiving or sending messages and/or streaming audio or video content). In the present disclosure the term communication service is occasionally used as a shorthand for the network components being used to provide the communication service.

A “user equipment (UE)” is any device used directly by an end-user to communicate. A user equipment can be, e.g., a hand-held telephone (e.g., a smartphone), a laptop computer, or any other portable or wearable device. In some examples, a user equipment is integrated in or connected to a larger apparatus and in some cases moves with this larger apparatus (e.g., a vehicle). In other examples a user equipment can also be a generally stationary device (e.g., a desktop computer). The term user equipment is not limited to a particular telecommunication standard (even though it is used in several standards starting from the UMTS standard).

A “model” is a computer-implemented entity for processing input data and generate output data based on the input data (e.g., a prediction of a quality of service).

The term “module” in the present disclosure refers to an entity having defined input and output interfaces for receiving and/or outputting data after having carried out a set of processing steps. A module can be defined in software (e.g., to be executed on generic hardware). However, in other examples a module can have dedicated hardware resources and/or be defined in dedicated hardware (e.g., a trained module can include a dedicated chip-set).

A “cell” in the present disclosure refers to an area in which the communication service can be consumed which is served by a particular set of network equipment (e.g., a base station). The communication service covers an extended area by multiple (potentially partially overlapping) cells. A user equipment (UE) moving about the extended area can enter and exit different cells.

### BRIEF DESCRIPTION OF THE DRAWINGS

FIG. 1 illustrates a system for predicting a quality of service (QOS) of a communication service according to the present disclosure.

FIG. 2 shows a flow diagram illustrating the methods for predicting a quality of service (QOS) of a communication service according to the present disclosure.

FIG. 3 shows an example hybrid machine-learning model according to the present disclosure.

FIG. 4a is a flow diagram of a handover process of a UE according to the 5G standard.

FIG. 4b is a graph showing example latency values (i.e., a quality of service) during a handover process.

FIG. 5 is (simulated) experimental data comparing the performance of hybrid machine-learning models according to the present disclosure with prior art techniques employing trained models.

### DETAILED DESCRIPTION

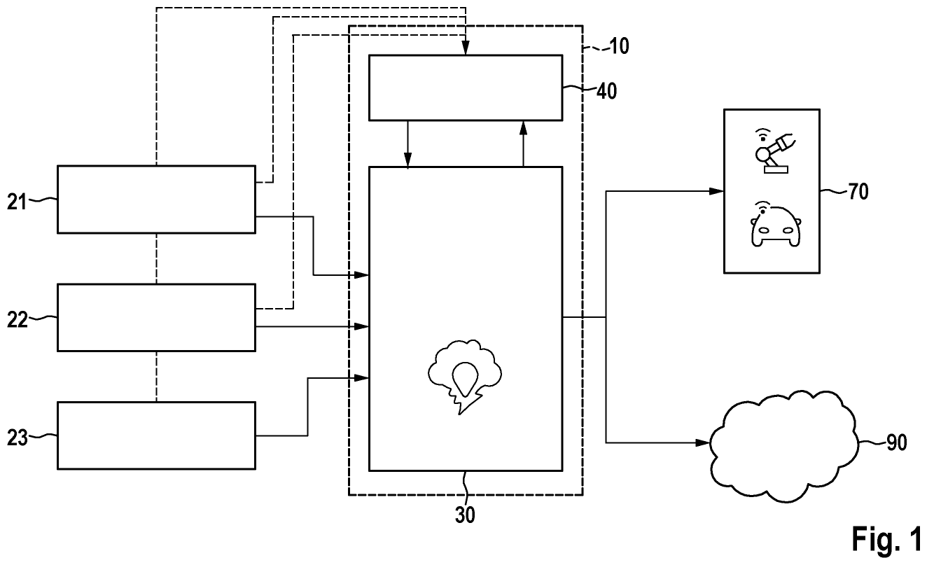

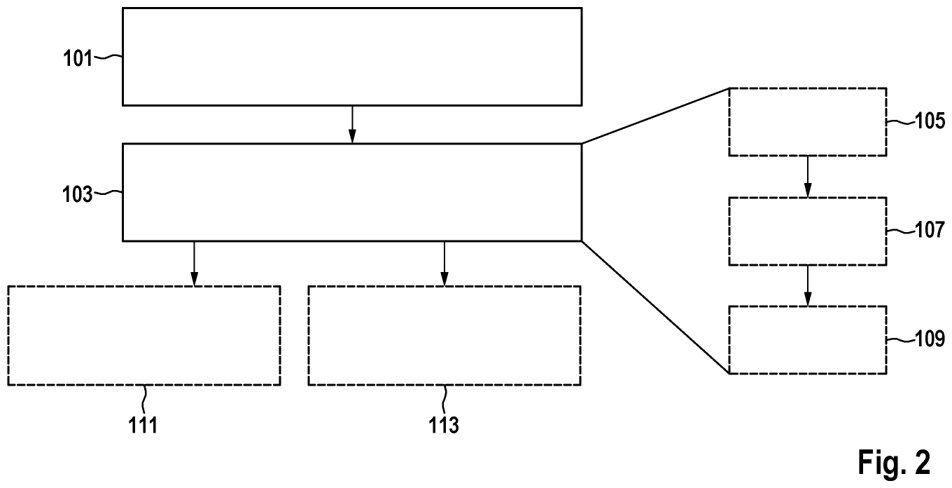

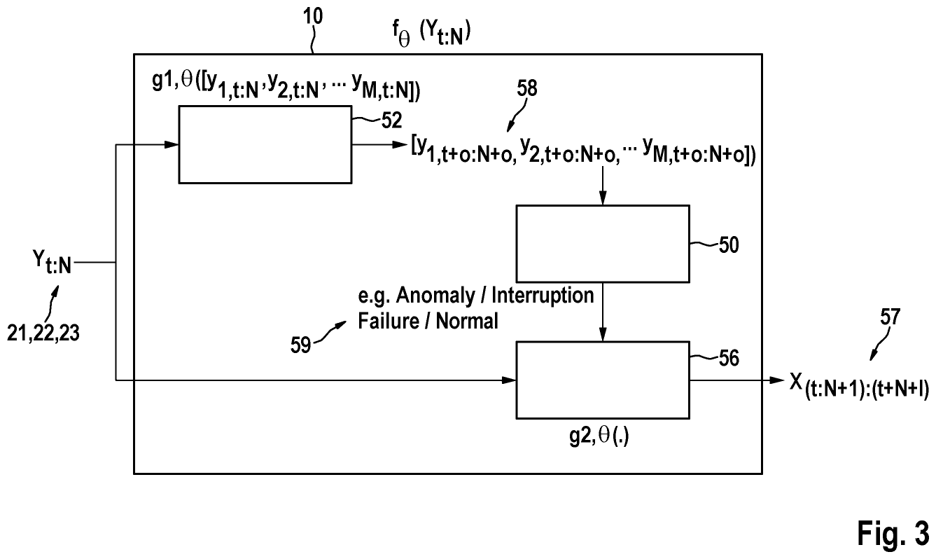

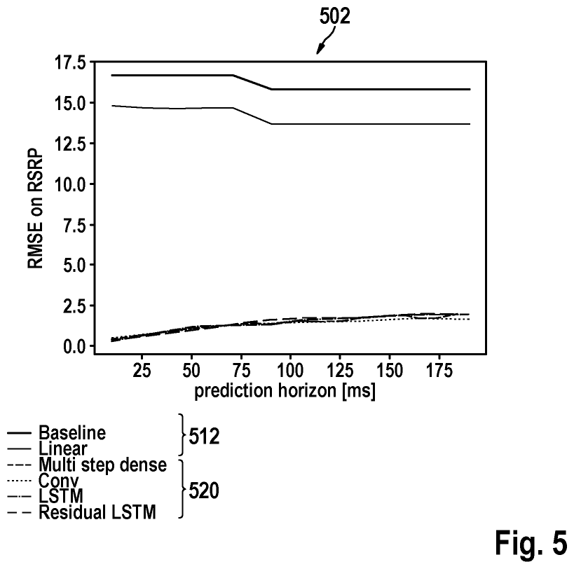

First, based on FIGS. 1 and 2, an overview over the techniques for predicting a quality of service of a communication service will be given. Subsequently, we will discuss further aspects of the hybrid machine-learning models and the systems they can be employed in according to the present disclosure in connection with FIG. 3. Last, data regarding the performance of hybrid machine-learning models according to the present disclosure will be presented in connection with FIG. 5.

FIG. 1 illustrates a system for predicting a quality of service of a communication service according to the present disclosure. FIG. 2 shows a flow diagram illustrating a method 100 for predicting a quality of service of a communication service according to the present disclosure. The steps/components of the method/system will be explained in the following section.

The method 100 for predicting a quality of service of a communication service includes receiving 101 data for predicting the quality of service of the communication service 21, 22, 23. In the example of FIG. 1, the data characterizing the communication service includes network information 21 (e.g., information regarding a user equipment, UE, taking part in the communication service and/or information regarding network equipment involved in the communication service, further examples will be given below), requirement specifications for the communication service 22 and external information characterizing an environment of the communication service 23. In general, the data characterizing the communication service 21, 22, 23 can include any data relevant for predicting a quality of service. For example, the data characterizing the communication service can include only one type of data listed above, or two of the three types of data listed above.

In some examples, as discussed above, network information 21 can include information regarding a user equipment (UE) taking part in the communication service. This information can include a measurement of a performance parameter at the user equipment (UE) (e.g., a channel measurement of a communication channel of the communication service, a buffer status of the user equipment (UE), and/or an occurrence of a handover trigger of the user equipment (UE) from a first cell of the communication service to a second cell of the communication service). In addition or alternatively, the network information 21 can include one or more measured performance indicators of a network employed in the communication service (e.g., a throughput measurement, a latency measurement, and/or a packet loss rate). In addition or alternatively, network information 21 can include state information regarding a network or a network component employed in the communication service (e.g., information regarding a cell load of a cell of the communication service, admission control information of user equipment (UE) in the communication service or a cell of the communication service, e.g., handover decision rules, and/or scheduling information of data communication in the communication service).

In some examples, requirement specifications for the communication service 22 can include requirements regarding a quality of service for the communication service. For instance, the requirements regarding a quality of service for the communication service can include one or more of a minimum data throughput requirement, a maximum latency requirement, an age (e.g., maximum age) requirement of data transmitted by the communication service, and/or a survival time of data in the communication service). In addition or alternatively, the requirement specifications for the communication service 22 can include communication service-specific adaptation requirements of the communication service.

The external information characterizing an environment of the communication service 23 (i.e., the components taking part in the communication service) can include information that characterizes a spatial and/or temporal environment in which the communication service takes place. For instance, the information characterizing an environment of the communication service 23 can include information regarding a user equipment density and/or traffic situation in the environment of the communication service (e.g., the user equipment (UE) and/or a network equipment involved in the communication service). In addition or alternatively, the information characterizing an environment of the communication service 23 can include geo-information related to the communication service. For instance, the geo-information related to the communication service can include location data regarding the user equipment (UE) and/or network equipment (e.g., a base station) involved in the communication process. In addition or alternatively, the geo-information related to the communication service can include movement data of a user equipment (UE) and/or an apparatus (e.g., a vehicle) including the user equipment (UE). In addition or alternatively, the geo-information related to the communication service can include information describing the terrain where the components taking part in the communication service (e.g., the user equipment (UE)) are located (e.g., a road type or a population density information).

The external information characterizing an environment of the communication service 23 can include sensor data obtained by sensors in the environment of the components involved in the communication service (e.g., user equipment (UE) and/or a network equipment involved in the communication service). For instance, the data obtained by the sensors can include data obtained by vehicle sensors (e.g., camera data, radar data and/or lidar data) and/or sensors in infrastructure components in the environment of the communication service (e.g., a camera monitoring the environment of the communication service). In addition or alternatively, the external information characterizing an environment of the communication service 23 can include information received from a remote management component of the communication service.

The data for predicting the quality of service of the communication service 21, 22, 23 can be pre-processed in any suitable manner before being input into a hybrid machine learning model 10.

The method 100 further includes processing 103; 105. 107, 109 the data for predicting the quality of service of the communication service by a hybrid machine learning model 10 to generate a prediction of the quality of service of the communication service.

In general, as illustrated in FIG. 1, the hybrid machine-learning model 10 includes a first module 40 configured to determine and/or predict 107 one or more characteristics of the communication service. The first module encodes expert knowledge concerning the communication service in an algorithm configured to determine and/or predict the one or more characteristics of the communication module and a trained second module 30 coupled to the first module and configured to receive data from the first module and/or configured to provide data to the first module for prediction of the quality of service (QOS) of the communication service. The trained second module 30 is set up by training using a training data set (i.e., a plurality of parameters of the trained second module 30 are set by training).

According to the present disclosure, the hybrid machine learning 10 model is “hybrid” as it does not consist solely in a trained model (i.e., a black box producing a prediction of the quality of service). Rather, the hybrid machine learning module includes a trained module but also the first module 40) (which can be not trained or only include particular trained elements in some examples) which can encode expert knowledge in a predetermined manner and interacts with the trained module (e.g., by providing information regarding the one or more characteristics of the communication service). Expert knowledge may refer to knowledge of the technical or physical causalities between input and output data. i.e., about conditions leading to specific characteristics of the communication service. These conditions of the communication service may be rare and underrepresented in typical training data. The first module may represent a human-readable and/or explicit mapping of these specific characteristics to conditions of the communication service.

In some examples, information regarding the communication service is encoded in the first module 40 in a human-readable manner and/or explicit manner (in form of an algorithm)-in contrast to trained modules which might only contain implicit information regarding the communication service. I.e., the first module can be a module set up independently of or without a training process. In particular, the first module may map input data to output data whereas the mapping has been provided with help of expert knowledge of the causalities between the input and the output data.

In this manner, the techniques of the present invention can improve the prediction of the quality of service in some situations as the first module can be used to expressly add expert knowledge in the hybrid model 10 to be used in the process of predicting the quality of service. In particular, issues of models which are set up to learn the entire characteristics of a process leading to a particular quality of service (including rare events) can be alleviated by expressly adding the expert knowledge in the model. The term “encoding” encompasses any process to translate expert knowledge (e.g., a description of the communication service or one of its components) in machine-executable form (e.g., by defining a set of rules and/or a sequence of steps that can be executed by a computing system based on the expert knowledge).

In general, the first module (i.e. the algorithm) is configured to determine and/or predict the one or more characteristics of the communication service. In some examples, the first module (i.e., the algorithm) defines a deterministic sequence of events and/or operations to determine and/or predict the one or more characteristics of the communication service. The first module can receive input data and process the input data according to the algorithm expressly defined based on the expert knowledge to determine and/or predict the one or more characteristics of the communication service. In some examples, the first module encodes expert knowledge regarding a communication protocol employed in the communication service (e.g., contained in a communication standard employed in the communication service). Further aspects of the first module will be discussed below in connection with FIG. 3.

The trained second module 30 can be any machine learning module that is trained to process data occurring in the process of prediction of the quality of service of the communication service. For example, the trained module 30 can include one or more artificial neural networks (e.g., a recurrent neural network, for instance an LSTM, a convolutional neural network or a feedforward neural network, or any combination thereof).

The trained second module 30 and the first module 40 can be coupled in different ways.

In some examples, the trained second module 30 is configured to generate input data for the first module 40. In addition or alternatively, the first module 40 can be configured to generate input data for the trained second module 30. In either case, the prediction of the quality of service can be improved in some examples. For instance, a prediction of the one or more characteristics of the communication service can be improved by the first module consuming output data of the trained second module 30 which might include information regarding subtle characteristics of the communication service. On the other hand, the trained second module 30 might benefit from the information received from the first module 40 (using the encoded expert knowledge). The data exchange between the trained second module 30 and the first module 40 can also involve multiple stages of exchanging data in the process of predicting the quality of service of the communication service.

In some examples, the trained second module 30 receives the data for predicting the quality of service of the communication service (or only a subset thereof) and determines and/or predicts one or more parameters of the communication service 105. These parameters can also be seen as intermediate parameters of the model since they are consumed internally by the hybrid machine-learning module 10 to predict the quality of service. For instance, the parameters of the communication service determined and/or predicted by the trained second module 30 can be one or more of the data types for predicting the quality of service of the communication service the communication service 21, 22, 23 discussed above. In some examples, the trained second module 30 receives input data and predicts future values of the input data (i.e., the same type of data). In some examples, the predicted one or more parameters of the communication service includes network information (e.g., information regarding a user equipment (UE) taking part in the communication service and/or information regarding network equipment involved in the communication service and external information characterizing an environment of the communication service. As discussed above, this information can in particular include location and/or speed information regarding a user equipment (UE), cell load information, signal strength information etc.

In addition or alternatively, the trained second module 30 can receive input data and can determine and/or predict future values of a different type of data than the input data (e.g., the trained second module 30 receives a first type of data for predicting the quality of service of the communication service described above and predicts another type of data, e.g., of the data for predicting the quality of service of the communication service described above).

In some examples, the first module 40 receives the determined and/or predicted one or more parameters of the communication service and determines and/or predicts the one or more characteristics of the communication module 107.

In some examples, the one or more characteristics determined and/or predicted by the first module 40 include one or more states of the communication service. The states can include one or more of a service interruption of the communication service (i.e., an established connection of the communication service is terminated), a service or connection failure (i.e., a connection of the communication service cannot be established), a state indicating a normal service (e.g., according to a predefined specification), and a state being the result of a rare event. In some examples, the first module 40 determines and/or predicts one or more of a handover of a user equipment involved in the communication service (e.g., a handover from a first cell to a second cell and/or from a first base station to a second base station), a connection failure or a service interruption due to a relative speed between a user equipment and a network equipment being overly large (e.g., above a predetermined limit), a connection failure or a service interruption due to insufficient network coverage, or a connection failure or a service interruption due to a predetermined event in the environment of the communication service.

In addition or alternatively, the one or more characteristics determined and/or predicted by the first module 40 can include one or more numerical values characterizing the communication service (e.g., a score or a parameter value).

The first module 40 can output the one or more characteristics in any suitable format. In some examples, the first module 40 outputs a probability that the one or more characteristics assume one or more values.

As already explained above, the hybrid machine-learning model 10 can have different topologies-FIG. 3 shows an example hybrid machine-learning model 10 according to the present disclosure.

In the example of FIG. 3, the trained second module includes a first sub-module 52 configured to receive data for predicting the quality of service of the communication service 21, 22, 23 and to determined and/or predict one or more parameters of the communication service 54, and a second sub-module 56 configured to receive the one or more characteristics of the communication module 58 output by the first module 40 and to predict the quality of service (QOS) 55 of the communication service. In other words, the hybrid machine-learning model models a function for determining a prediction of the quality of service (QOS) 55 based on the data characterizing the communication service 21, 22, 23. In the example of FIG. 3, the trained second module is split into two sub-modules 52, 56. In other examples, the trained second module can be split into more than two sub-modules. In any case, the different sub-modules can be coupled to receive data and/or provide data to/from other sub-modules and/or the first module 40. The first and/or second sub-module 52, 56 can include an artificial neural network (the same is true for any additional sub-module discussed below).

In some examples, the hybrid machine-learning model can include multiple modules encoding expert knowledge concerning the communication service in different algorithms configured to determine and/or predict one or more characteristics of the communication module. The multiple modules encoding expert knowledge can be coupled with multiple sub-modules of a trained second module to exchange data for predicting of the quality of service (QOS) of the communication service.

The trained second module (e.g., the first and second sub-modules 52, 56) can include a plurality of parameters, (e.g., weights or hyper-parameters) that can be set by training the trained module (e.g., the first and second sub-modules 52, 56) with suitable training data sets (we refer to a trained module in the preceding sections even if the trained module has not yet undergone training/all specified training epochs).

In the example of FIG. 3, the hybrid machine-learning model 10 is configured to generate a plurality of values of predictions of the quality of service 57, x_{(t+N+1):(t+N+1)} (e.g., a time series of predictions of the quality of service). In general, the hybrid machine-learning models of the present disclosure can be configured to continuously predict one or more values of the quality of service, or on demand (e.g., upon occurrence of predetermined trigger events). Likewise, in the examples of FIG. 3, the hybrid machine-learning model 10 receives a time series including multiple values for one or more of the types of data for predicting the quality of service of the communication service 21, 22, 23 ([y_{k,t}, y_{k,t+}1. . . y_{k,t+N}], where the index k runs through the different types of input data). In other examples or additionally, the hybrid machine-learning model 10 can receive only one value of certain types of data for predicting the quality of service of the communication service 21, 22, 23 at a time.

In some examples, a feature matrix, Y_{t: N}, can be generated from vectors including the time-series of data for the different types of data for predicting the quality of service of the communication service: 21, 22, 23. This feature matrix, Y_{t:N}, can be processed by the first sub-module 52 to determine and/or predict the one or more parameters 58 of the communication service 54, which are in turn fed into the first module 40.

As discussed above, the first module 40 can determine and/or predict one or more characteristics of the communication service 59, e.g., one or more states of the communication service 59.

In some examples, a state can include the occurrence of an anomaly in the communication service. In addition or alternatively, the state can include the occurrence of a service failure in the communication service (e.g., a failure to hand over a user equipment to another cell, a failure to connect to another device, or another type of failure). In addition or alternatively, the state can include the occurrence of an interruption of the communication service. In addition or alternatively, the state can include the occurrence of a normal operation of the communication service (e.g., the absence of the anomalies, failures and/or interruptions discussed above).

The determination and/or prediction of one or more states of the communication service 59 (or any other characteristic determined or predicted by the first module 40) can in turn be input into the second sub-module 56 of the trained second module. The second sub-module 56 of the trained second module can process the determination and/or prediction of one or more states of the communication service 59 (or any other characteristic determined or predicted by the first module 40) and optionally data for predicting the quality of service of the communication service (which can the data received by the first sub-module 52 and/or different data for predicting the quality of service of the communication service) and generate the prediction of the quality of service.

The features described in the preceding sections in connection with a trained module including two sub-modules 52, 56 can equally applied in situations where the trained module includes no sub-modules or a different number of sub-modules (unless being specific to a case with exactly two sub-modules).

In some examples, different subsets of the data for predicting the quality of service of the communication service are processed by different modules of the hybrid machine-learning model. For instance, a first trained sub-module (e.g., sub-module 52 of FIG. 3) of the trained second module can receive and process a first subset of the data for predicting the quality of service of the communication service received by the hybrid machine-learning model. A second trained sub-module (e.g., sub-module 56 of FIG. 3) of the trained second module can receive and process a second subset of the data for predicting the quality of service of the communication service received by the hybrid machine-learning model different from the first subset (e.g. including at least one different type of data). If the hybrid machine-learning model includes further trained sub-modules, these further trained sub-modules can receive and process further respective subsets of the data for predicting the quality of service of the communication service received by the hybrid machine-learning model different from the other subsets.

In addition or alternatively, the first module encoding expert knowledge can receive and process subsets of the data for predicting the quality of service of the communication service received by the hybrid machine-learning model different from the subsets received by the trained (sub-) modules.

In some examples, the subsets of data for predicting the quality of service of the communication service and the different sub-modules of the trained second module are selected for determining and/or predicting different parameters of the communication service. For instance, different parameters of the communication service can relate to different aspects of the communication service (e.g., different aspects of a communication protocol of the communication service). The different parameters of the communication service relating to different aspects of the communication service (e.g., different aspects of a communication protocol of the communication service) can be input to different (first) modules encoding expert knowledge as described in the present disclosure.

Splitting the process of predicting the quality of service so that different modules process data relating to different aspects of the communication service (i.e., again by employing expert knowledge) can result in modules of lower complexity (e.g., having a lower number of input values and/or internal parameters). This can in turn make training of the modules easier and faster and/or improve the accuracy and/or reliability of a prediction of the quality of service of the communication service in some examples.

Returning to FIG. 1, the techniques of the present disclosure can include using the predictions of the quality of service in various ways.

In some examples, a method for improving a quality of a communication service includes predicting a quality of service (QOS) of a communication service according to any of the techniques of the present disclosure and triggering a response 111, 113 if the predicted quality of service (QOS) of the communication service fulfills one or more predetermined criteria. The response can include one or more of a measure to counter-act a predicted drop in QoS 111 or a measure to mitigate a predicted drop in QoS 113 (e.g., at a user equipment or a management component of the communication service). The counter-action and the mitigations techniques can be designed to counter-act/mitigate the predicted drop in QoS for a particular user equipment or for a plurality of user equipment.

For instance, the response can include switching a communication channel used to deliver the communication service. For instance, a user equipment (UE) can be communicating over a first communication channel using a first protocol. In response to a prediction of a drop in the quality of service of the first communication channel the equipment (UE) can be switched to a second communication channel (e.g., from a near-field communication channel to a wide-area communication channel, or from a first cell to a second cell, or from one radio access technology to another radio access technology). This can avoid, e.g., a service interruption due to the drop of quality of service of the first communication channel.

In addition or alternatively, the response can include establishing an additional communication channel for the communication service (e.g., for a user equipment (UE)). For instance, a communication service can support multi-connectivity where a user equipment (UE) uses two or more communication channels to receive or transmit data in a single communication process. For instance, data can be sent and/or received from a user equipment (UE) using different base stations in a single communication process.

In addition or alternatively, the response can include adapting one of more parameters of the communication service. For instance, a transmission frequency or a bandwidth of the communication service can be adapted in response to predicting a drop (or an increase) in the quality of service. Again, this can avoid, e.g., a service interruption or a connection failure due to a drop of quality of service.

In addition or alternatively, the response can include adapting an admission control of users of the communication service (e.g., by a management component of the communication service)

In addition or alternatively, the response can include adapting an employment of network resources used to deliver the communication service. For instance, if a drop in quality of service is predicted in a particular area, additional network resources can be allocated in this area to at least partially avoid the drop, and the ensuing consequences.

The responses can include responses performed by the user equipment or particular network equipment (i.e., to influence a particular communication connection) but also responses involving changes on the network level (i.e., involving multiple user equipment and/or network equipment to optimize the communication service on the network level).

In FIG. 1, the hybrid machine-learning module can output data to a user equipment 70 and/or to the network delivering the communication service 80 (e.g., a management component of the communication service). The user equipment 70 and/or to the network delivering the communication service 80 can then carry out one or more of the responses discussed above.

In some examples, a prediction of the one or more characteristics of the communication service generated by the first module encoding expert knowledge can be a prediction of the quality of service of the communication device. For instance, as discussed above, the first module can predict an anomaly, a service interruption and/or a connection failure of the communication service. These predictions are (relatively simple) predictions of a quality of service of the communication service. In some examples, a response can be carried out based on the prediction of the one or more characteristics of the communication service generated by the first module encoding expert knowledge (e.g., one or more of the responses discussed above).

In still other examples, a prediction of the quality of service of the communication service can include both a prediction of the one or more characteristics of the communication service generated by the first module encoding expert knowledge and predictions of the quality of service (e.g., one of the performance parameters discussed above) by the trained second module (or one of its sub-modules). In some examples, a response can be carried out based on the prediction of the one or more characteristics of the communication service generated by the first module encoding expert knowledge and the predictions of the quality of service (e.g., one of the parameters discussed above) by the trained second module (e.g., one or more of the responses discussed above).

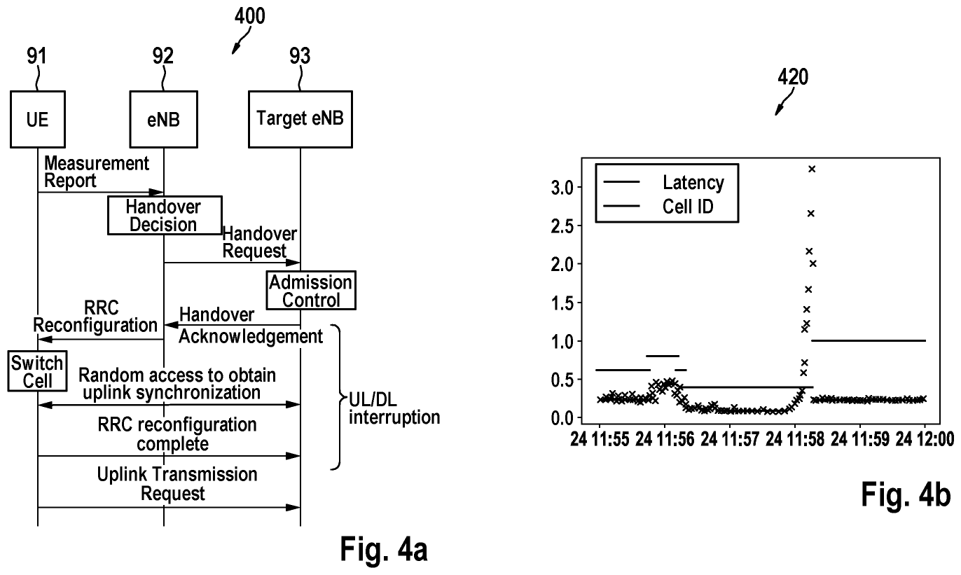

As mentioned above, FIG. 4a shows an example of a sequence of events 400 of a handover protocol according to a particular communication protocol. FIG. 4b is a corresponding graph 42 showing example latency values (i.e., a quality of service) during a handover process.

As can be seen, a user equipment 91 currently uses a first cell 92 and shall be handed over to second cell 93 of the communication service. Without going into the details of the process, it can be seen that the handover includes a complex sequence of events/operations. Information regarding this sequence of events/operations can be encoded in the first module encoding expert knowledge of the present disclosure (the example of a handover is only illustrative, the first module of the present disclosure can encode various other information relating to communication protocols employed in the communication service and/or the environment of the communication service). In this manner, the hybrid machine-learning model does not have to learn the behavior of the communication service in all respects but can make use of the express expert knowledge to handle various situations when predicting the quality of service of the communication service.

In the preceding sections, the techniques of the present disclosure have been discussed with little reference to the hardware environments in which the methods are carried out. In general, the systems for prediction of the quality of service can be embodied/hosted in/on any suitable hardware for carrying out the techniques of the present disclosure. In some examples, the system for prediction of the quality of service can be embodied/hosted in/on a user equipment (UE) or a system including a user equipment (e.g., a vehicle). In other examples, the system for prediction of the quality of service can be embodied/hosted in/on a network equipment (e.g., a base station of the communication service). In still other examples, the system for prediction of the quality of service can be embodied/hosted in/on a remote location connected to the components taking part in the communication service over a network. The system for prediction of the quality of service can be distributed over multiple locations and/or be hosted in a cloud-computing environment. Depending on the respective setup, the system for prediction of the quality of service can communicate with other components (e.g., a user equipment or network equipment or a network management component) to receive the data characterizing the communication service and/or deliver the prediction of the quality of service (QOS) of the communication service. The prediction of the quality of service (QOS) of the communication service can be further processed by the other components (e.g., a user equipment or network equipment or a network management component) to generate one of the responses discussed above.

In some examples, the prediction of the quality of service (QOS) of the communication service can also be used in a design process to improve the communication service.

In some examples, the systems for prediction of the quality of service can be executed on a computer system including at least one processor and memory for storing instructions which when carried out by the processor make the processor to execute the steps of the techniques for prediction of the quality of service (QOS) of the communication service according to the present disclosure.

The present disclosure also relates to a computer-program being configured to carry out the steps of the methods of the present disclosure.

The present disclosure also relates a computer-readable medium or signal containing the computer program of the present disclosure.

FIG. 5 is (simulated) data 500 comparing the performance of hybrid machine-learning models according to the present disclosure with prior art techniques employing trained models. In the example of FIG. 5 a predicted Reference Signal Received Power (RSRP—a signal strength measurement) is compared between prior art techniques 510 and techniques of the present disclosure 520. In detail, a first sub-module of hybrid model as set out in FIG. 3 has been compared with a “simple” linear model in the following manner. In the example setup, the Reference Signal Received Power is a parameter output by the first sub-module of the trained second module (see FIG. 3). This first sub-module has been implemented by different types of neural networks (“Multi step dense”, “Conv”, LSTM and “Residual LSTM”). The comparative examples are linear models (“Baseline” and “Linear”) set up to predict the Reference Signal Received Power. As can be seen, the error of the prediction (a RMSE in FIG. 5) by the first sub-module of the trained module is lower than the comparative examples, whereas the employed neural network topology has relatively little impact on the prediction error. A lower error of a Reference Signal Received Power might in turn mean that the determination and/or prediction of the first module and the subsequent prediction of the quality of service is also more precise. This shows that the techniques of the present invention can yield an improved prediction of the quality of service of a communication service in some situations.

1. A method for predicting a quality of service of a communication service, the method comprising:
receiving data for predicting the quality of service of the communication service; processing the data for predicting the quality of service of the communication service by a hybrid machine learning model to generate a prediction of the quality of service (QOS) of the communication service,
wherein the hybrid machine-learning model includes:
a first module configured to determine and/or predict one or more characteristics of the communication service,
wherein the first module encodes expert knowledge concerning the communication service in an algorithm configured to determine and/or predict the one or more characteristics of the communication module; and
a trained second module coupled to the first module,
wherein the trained second module receives data from the first module and/or provides data to the first module for predicting of the quality of service of the communication service.

2. The method of claim 1, wherein the trained second module generates input data for the first module and/or wherein the first module generates input data for the trained second module.

3. The method of claim 1, wherein the trained second module is configured to receive a subset of the data for predicting the quality of service of the communication service and to predict one or more parameters of the communication service.

4. The method of claim 3, wherein the first module receives the predicted one or more parameters of the communication service and determines and/or predicts the one or more characteristics of the communication service.

5. The method of claim 1, wherein the trained second module includes a first sub-module which receives a subset of the data for predicting the quality of service of the communication service and determines and/or predicts one or more parameters of the communication service, and a second sub-module which receives the determined and/or predicted one or more characteristics of the communication service and predicts the quality of service of the communication service.

6. The method of claim 1, wherein the data for predicting the quality of service of the communication service includes one or more of information regarding a user equipment taking part in the communication service, information regarding network equipment involved in the communication service, requirement specifications for the communication service and external information characterizing an environment of the communication service.

7. The method of claim 1, wherein the first module is configured to determine and/or predict one or more characteristics including a service interruption, a service failure, a normal service and a state being the result of a rare event.

8. The method of claim 1, wherein the first module encodes expert knowledge regarding a communication protocol employed in the communication service, optionally a sequence of events being defined in the communication protocol.

9. The method of claim 1, wherein the first module is configured to determine and/or predict one or more of a handover of a user equipment involved in the communication service, a service interruption or a connection failure, optionally a connection failure or service interruption due to a relative speed between the user equipment and network equipment being overly large, a connection failure or service interruption due to insufficient network coverage, or a connection failure or service interruption due to a predetermined event in the environment of the communication service.

10. A method for improving a quality of a communication service; comprising:
predicting a quality of service of a communication service according to claim 1; and
triggering a response if the predicted quality of service of the communication service fulfills one or more predetermined criteria.

11. The method of claim 10, wherein the response includes one or more of a measure to counter-act a predicted drop in quality of service or a measure to mitigate a predicted drop in quality of service.

12. The method of claim 10, wherein the response includes switching a communication channel used to deliver the communication service;
establishing an additional communication channel for the communication service;
adapting one of more control parameters of the communication service; and
adapting an admission control of users of the communication service;
adapting an employment of network resources used to deliver the communication service.

13. A system for predicting a quality of service of a communication service, the system comprising:
a hybrid machine-learning model comprising:
a first module configured to determine and/or predict one or more characteristics of the communication service,
wherein the first module encodes expert knowledge concerning the communication service in an algorithm configured to determine and/or predict the one or more characteristics of the communication module; and
a trained second module coupled to first module and configured to receive data from the first module and/or configured to provide data to the first module for predicting of the quality of service (QOS) of the communication service,
wherein the system is configured to carry out the steps of the methods of claim 1.

14. (canceled)

15. A non-transitory_computer-readable medium containing instructions that when executed by a computer cause the computer to predict a quality of service of a communication service, by:
receiving data for predicting the quality of service of the communication service;
processing the data for predicting the quality of service of the communication service via a hybrid machine learning model to generate a prediction of the quality of service (QOS) of the communication service,
wherein the hybrid machine-learning model includes:
a first module configured to determine and/or predict one or more characteristics of the communication service,
wherein the first module encodes expert knowledge concerning the communication service in an algorithm configured to determine and/or predict the one or more characteristics of the communication module; and
a trained second module coupled to the first module,
wherein the trained second module receives data from the first module and/or provides data to the first module for predicting of the quality of service of the communication service.
